(19) United States
(12) Patent Application Publication
(10) Pub. No.: US 2025/0108554 A1
(43) Pub. Date: Apr. 3, 2025

(54) EMBROIDERY SIMULATION SYSTEM

(71) Applicant: WORLD EMBLEM INTERNATIONAL, INC., Hollywood, FL (US)

(72) Inventor: Manuel Figueroa, Cooper City, FL (US)

(73) Assignee: WORLD EMBLEM INTERNATIONAL, INC., Hollywood, FL (US)

(21) Appl. No.: 18/477,443

(22) Filed: Sep. 28, 2023

(51) Int. Cl. B29C 59/02; B29C 33/38; B29C 59/00; B29K 27/06; B29K 75/00; B29K 83/00; B29L 31/00; B32B 3/26; B32B 27/08; B32B 27/28; B32B 27/30; B32B 27/40; B32B 37/10; B32B 37/12; B32B 37/24; B32B 38/00; B32B 38/06

(52) U.S. Cl. CPC B29C 59/026; B29C 33/3835; B29C 33/3842; B29C 59/002; B29C 59/005; B32B 3/263; B32B 27/08; B32B 27/283; B32B 27/304; B32B 27/40; B32B 37/1045; B32B 37/12; B32B 37/24; B32B 38/06; B32B 38/145; B29C 2795/007; B29K 2027/06; B29K 2075/00; B29K 2083/00; B29L 2031/722; B32B 2037/243; B32B 2250/24; B32B 2255/10; B32B 2255/26; B32B 2274/00; B32B 2327/06; B32B 2327/18; B32B 2375/00; B32B 2383/00; B32B 2451/00

(57) ABSTRACT

An embroidery simulation system and method configured to create desired artwork on a readily attachable base member having the appearance of simulated embroidery is disclosed. The system and method are configured to enable an emblem to be created that resembles embroidery and is configured to enable the emblem to be attached to goods, that were traditionally embroidered, in a fraction of the time previously needed to embroider that same article. In addition, the emblem to be created by the system and method may be attached to goods that traditionally we unable to be embroidered, such as drinking mugs and other hard surfaced goods. The embroidery simulation system and method enhance the flexibility of a company by increasing the type and diversity of product to which an emblem can be affixed while also reducing inventory requirements for resellers of goods.

### BACKGROUND

The present application relates to systems for embroidering designs on items and more particularly to systems configured to create simulated embroidery.

Embroidery has long been used to add corporate logos and other designs to garments, such as shirts and hats. Embroidery has generally perceived as having a better appearance than other types of systems for creating a logo on a garment, such as screen printing and the like. Embroidery is often created with use of sowing machines that may or may not be controlled via a processor of some kind, such as a computer. While machinery has often been used to create embroidery, even use of machinery still takes time to create embroidered designs on garments. Thus, a need exists for creating aesthetically pleasing designs on items at a faster pace.

### SUMMARY OF THE INVENTION

An embroidery simulation system and method configured to create desired artwork on a readily attachable base member with the appearance of simulated embroidery is disclosed. The system and method are configured to enable an emblem to be created that resembles embroidery and is configured to enable the emblem to be attached to goods, that were traditionally embroidered, in a fraction of the time previously needed to embroider that same article. In addition, the emblem to be created by the system and method may be attached to goods that traditionally we unable to be embroidered, such as drinking mugs and other hard surfaced goods. The embroidery simulation system and method enhances the flexibility of a company by increasing the type and diversity of product to which an emblem can be affixed while also reducing inventory requirements for resellers of goods. Instead, resellers of goods aren't required to have on hand numerous goods with emblems already attached but can have blank goods on hand and emblems that can be attached to whichever goods a customer desires.

In at least one embodiment, an embroidery simulation system is disclosed may include one more sheets containing desired artwork in two dimensions and one or more bonding layers. The one or more bonding layers may be positioned between the sheet and the die, whereby the bonding layer is configured to enable the sheet to be attached to a base item. In at least one embodiment, the sheet may be formed from one or more polyvinyl chloride sheets. In at least one embodiment, the sheet may be formed from one or more thermoplastic polyurethane sheets. In at least one embodiment, the sheet may be formed from one or more silicone sheets. The sheet may include one or more polytetrafluoroethylene coating on the sheet.

The bonding layer of the embroidery simulation system may be formed from one or more polyurethane bonding films, which is usable attach the finished base item to a soft item, such as, but not limited to, a garment. The bonding layer of the embroidery simulation system may be formed from one or more polyvinyl chloride (PVC) materials. In another embodiment, the bonding layer of the embroidery simulation system may be formed from one or more pressure sensitive adhesives, which is usable attach the finished base item to a hard item, such as, but not limited to, a drinking mug.

The embroidery simulation system may also include one or more dies configured to an impression of desired artwork. In at least one embodiment, the desired artwork may be an identical copy of desired artwork printed on at least one sheet used to create the base item attachable to a soft good, such as, but not limited to, a garment or a hard good, such as, but not limited to, a drinking mug. The die may contain impressions forming the desired artwork in three dimensions with simulated embroidery threads. The die may be formed from any appropriate material, such as, but not limited to, aluminum, via a computer numerical control machine from a file containing a gray scale version of the desired artwork. The gray scale version of the desired artwork may be formed from a simulated image produced with software on a computer. The gray scale version of the desired artwork may be converted to a vector.

A method of creating desired artwork on one or more readily attachable base members with the appearance of simulated embroidery is disclosed. The method of creating simulated embroidery may include positioning one or more sheets containing desired artwork in two dimensions on a die configured to include the desired artwork. The method may also include positioning one or more bonding layers between the sheet and the die, which may be configured to enable a bonding layer to be attached to a base item. The method may also include pressing the sheet containing desired artwork on a die and the bonding layer using a press to create finished desired artwork. The action of pressing the sheet on a die may, in at least one embodiment, create desired artwork in three dimensions with simulated embroidery threads together with a bonding layer enabling the finished desired artwork to be attached to the base item, wherein the die contains impressions forming the desired artwork. The method may include positioning one or more sheets formed from one or more polyvinyl chloride sheets on the die. The method may include positioning one or more sheets formed from one or more thermoplastic polyurethane sheets on the die. The method may include positioning one or more sheets formed from one or more silicone sheets on the die. The method may include positioning one or more sheets including one or more polytetrafluoroethylene coating. The action of pressing the sheet containing desired artwork and bonding layer on a die using a press may include pressing the sheet using a press comprising a high frequency machine stamp.

The method of creating desired artwork including positioning one or more bonding layers between the one or more sheets and the die may include positioning one or more bonding layers formed from a polyurethane bonding film. In at least one embodiment, the method may include positioning one or more bonding layers formed from a pressure sensitive adhesive between the sheet and the die.

The method may include printing the desired artwork in two dimensions on the at least one sheet. Printing the desired artwork in two dimensions on the sheet may include printing desired artwork having an appearance of embroidery threads.

The method may also include creating the die with a three dimensional impression of the desired artwork. The three dimensional impression of the desired artwork on the die may include simulated embroidery threads. The impression of the desired artwork on the die may be created via a computer numerical control machine from a file such as, but not limited to, a file containing a gray scale version of the desired artwork. The method may include creating the die by cutting material from a block of material using the file of the gray scale image of desired artwork with a computer numerical control machine to create a three dimensional impression of the desired artwork with simulated embroidery threads.

Once the sheet with desired artwork and the bonding layer have been pressed together on the die, excessive material may be removed. In particular, the method may include removing excessive sheet material from the sheet after the sheet has been pressed to create a standalone artwork member capable of being attached to the base item. In at least one embodiment, the method may include removing excessive material when the sheet with desired artwork and the bonding layer are pressed together on the die because the die may include one or more trimming edges configured to trim the sheet and bonding layer when pressed onto the die.

A method of forming a base sheet of a simulated embroidery system is disclosed. In at least one embodiment, the method may include creating one or more sheets with liquid polyvinyl chloride. The method of creating one or more sheets may include creating the sheet with liquid polyvinyl chloride. The method of creating one or more sheets may include curing the liquid polyvinyl chloride by baking the sheet at temperatures between 250 degrees Fahrenheit and 500 degrees Fahrenheit for between ten seconds and 120 seconds. In at least one embodiment, curing the liquid polyvinyl chloride by baking the sheet may occur by baking the sheet at a temperature of about 350 degrees Fahrenheit for between 30 seconds and 75 seconds. The method may include the action of creating the sheet with a top layer of polypropylene.

The method may also include printing the desired artwork in two dimensions on one or more sheets. The action of printing the desired artwork in two dimensions on the sheet may include printing desired artwork having an appearance of embroidery threads. The method may also include creating the die via a computer numerical control machine. The action of creating the die may include creating the die with impressions simulating threads forming embroidery. The action of pressing the sheet containing desired artwork on a die using a press may include pressing the sheet using a press comprising a high frequency machine stamp.

During use, once the sheet with desired artwork and bonding layer are pressed together and the excessive material has been removed, the standalone artwork member is ready to be attached to a desired base item. The standalone artwork member may be attached to a desired base item, such as, but not limited to, soft surfaced goods when the bonding layer is a polyurethane bonding film and hard surfaced goods when the bonding layer is a polypropylene film. The system and methods disclosed herein saves significant amounts of time ordinarily required for embroidery. An embroidered logo is generally perceived as having a better appearance than other types of installation and attachment systems. The system and methods disclosed herein enables one to enjoy the aesthetics of desired artwork having simulated embroidery that very closely mimics authentic embroidery without requiring the investment of time needed to create an embroidered item on a good.

A merchant, business or other may create numerous standalone artwork members and keep them on hand ready to be attached to a soft surfaced good or hard surfaced good when desired and once a customer or other decisionmaker has decided which base item the standalone artwork member is to be attached. By not requiring an item to be embroidered ahead of time for a potential customer, one need not have multiple sizes of each garment and in numerous colors already embroidered with a logo. Instead, the garments or other items need not have a logo attached thereto until after a customer chooses which item to purchase. One a customer decides on an item, the standalone artwork member may be attached to the item by heating the standalone artwork member or by pressing the standalone artwork member on a base item.

An advantage of the embroidery simulation system is that the embroidery simulation system is capable of creating emblems that are readily attachable to soft or hard goods and simulate embroidery while needing less time than embroidery.

Another advantage of the embroidery simulation system is that the system saves significant amounts of time ordinarily required for embroidery.

Yet another advantage of the embroidery simulation system is that the system generates simulated embroidery that very closely mimics authentic embroidery without requiring the investment of time needed to create an embroidered item on a good.

Another advantage of the embroidery simulation system is that the system is usable to create emblems resembling embroidery that can be kept on hand and attachable to any number of soft or hard goods that would take significantly more time if required to be attached to an article by embroidery.

Still another advantage of the embroidery simulation system is that the system eliminates the need to have large inventories of conventional emblems because the system can quickly create an emblem in a desired color combination on demand rather than the considerable time needed to create a conventional emblem.

Another advantage of the embroidery simulation system is that the system is that emblems can be created in any color scheme with the system and is not limited to a prechosen color as with conventional emblems.

These and other advantages are described in detail below.

### BRIEF DESCRIPTION OF THE DRAWINGS

The accompanying drawings, which are incorporated in and form a part of the specification, illustrate embodiments of the presently disclosed invention and, together with the description, disclose the principles of the invention.

FIG. 1 is an exploded perspective view of the embroidery simulation system.

FIG. 2 is a perspective view of good with an emblem including simulated embroidery thereon.

FIG. 3 is a top view of simulated embroidery of the embroidery simulation system.

FIG. 4 is a top view of an emblem including simulated embroidery thereon.

FIG. 5 is a top view of desired artwork of the embroidery simulation system.

FIG. 6 is a sheets configured to receive desired artwork to form one or more emblems that are attachable to goods.

FIG. 7 is a partial perspective view of a die including impressions on the die forming desired artwork.

FIG. 8 is a flow chart of a method of creating simulated embroidery.

FIG. 9 is a flow chart of a method of creating a die usable to create a standalone item with desired artwork in three dimensions with simulated embroidery threads.

FIG. 10 is a flow chart of a method of forming a base sheet of a simulated embroidery system.

### DETAILED DESCRIPTION OF THE INVENTION

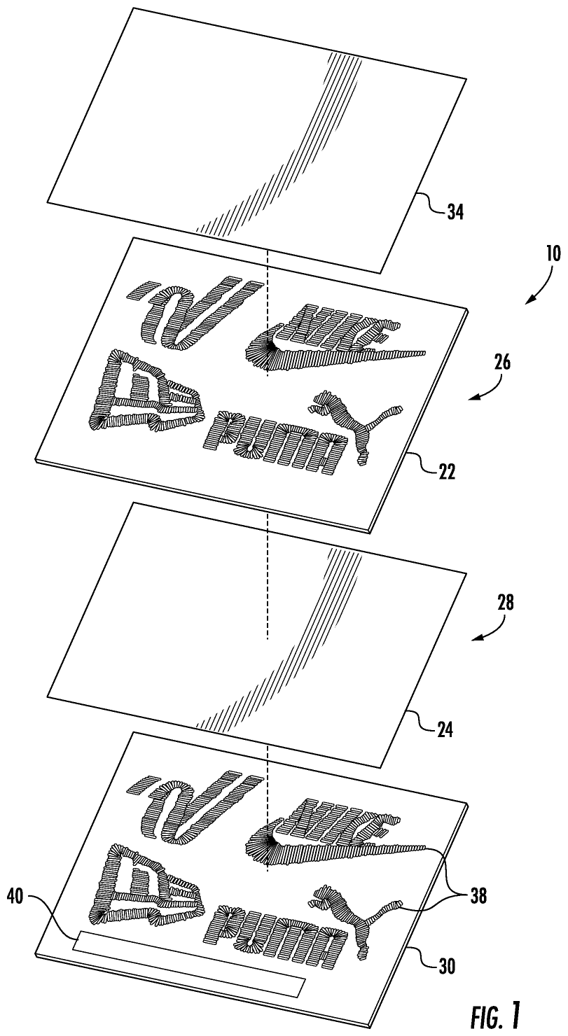

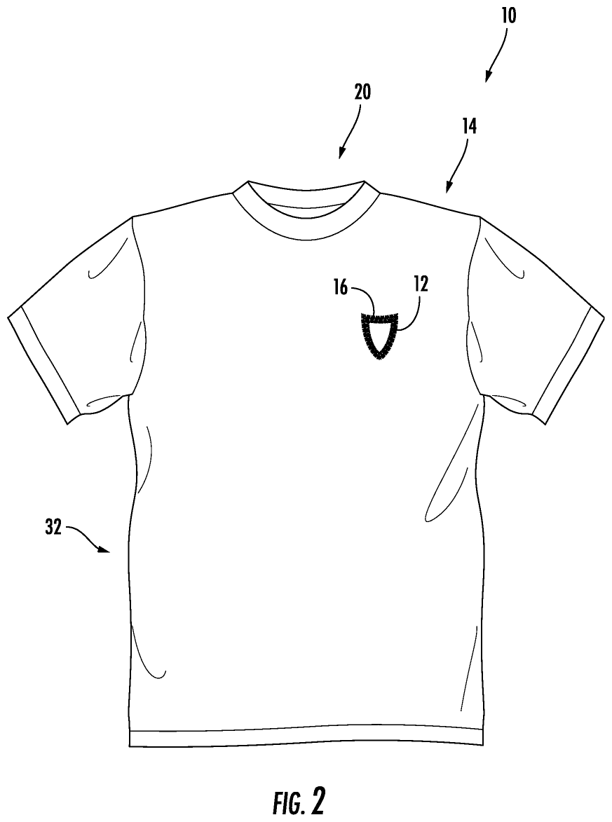

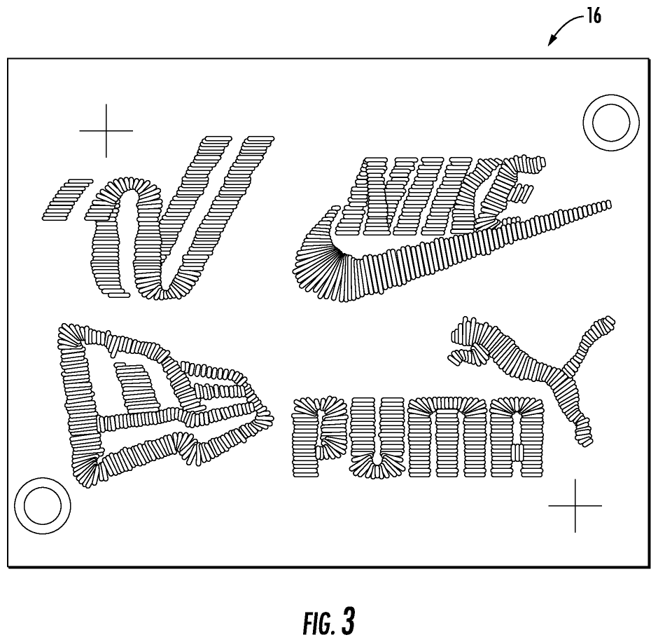

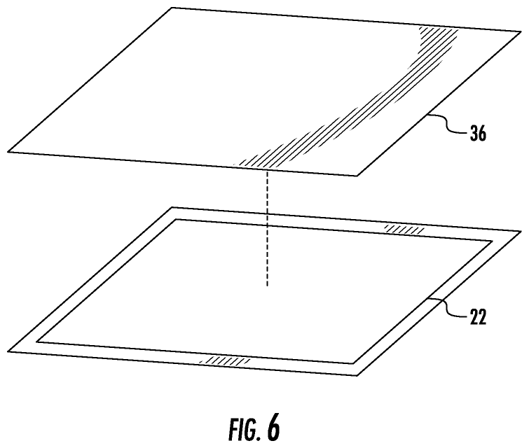

As shown in FIGS. 1-10, an embroidery simulation system 10 and method configured to create desired artwork 12 on a readily attachable base member 14 having the appearance of simulated embroidery 16 is disclosed. The system 10 and method are configured to enable an emblem 18 to be created that resembles embroidery and is configured to enable the emblem 18 to be attached to goods 20, that were traditionally embroidered, in a fraction of the time previously needed to embroider that same article. In addition, the emblem 18 to be created by the system 10 and method may be attached to goods 20 that traditionally we unable to be embroidered, such as drinking mugs and other hard surfaced goods. The embroidery simulation system 10 and method enhances the flexibility of a company by increasing the type and diversity of product to which an emblem 18 can be affixed while also reducing inventory requirements for resellers of goods 20. Instead, resellers of goods 20 aren't required to have on hand numerous goods 20 with emblems 18 already attached but can have blank goods 20 on hand and emblems 18 that can be attached to whichever goods 20 chosen by a customer.

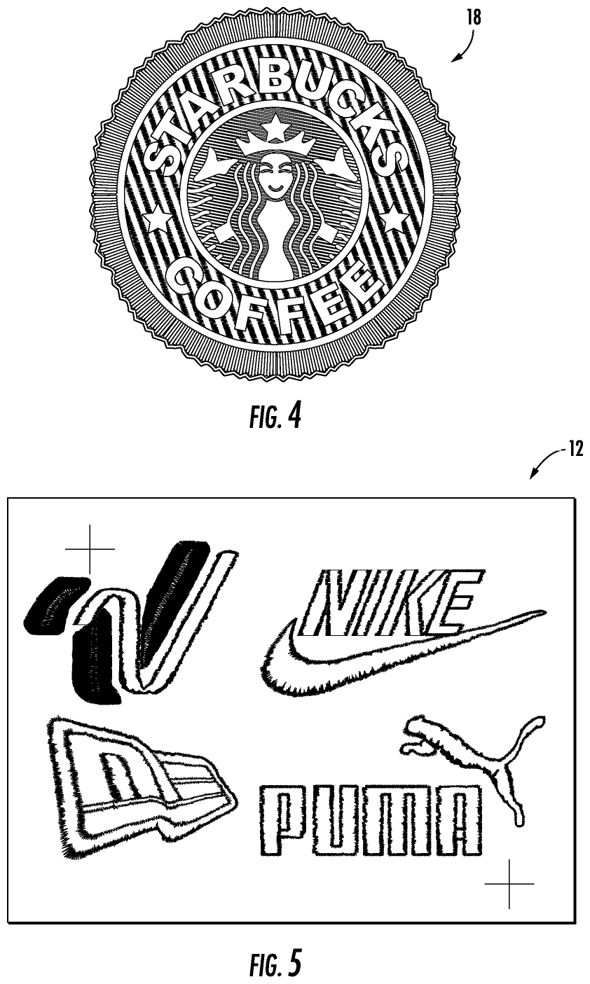

The embroidery simulation system 10 may include simulated embroidery emblems 18, as shown in FIG. 4, formed from one or more sheets 22, as shown in FIG. 1, containing desired artwork 12 in two or more dimensions and one or more bonding layers 24. The sheet 22 may be a top layer 26 and the bonding layer 24 may be a bottom layer 28. During manufacture of the simulated embroidery emblems 18, the bonding layer 24 may be positioned between the sheet 22 and a die 30. As such, the bonding layer 24 is configured to enable the sheet 22 to be attached to a base item 32. The sheet 22 may be configured to have desired artwork 12 printed on the sheet 22. The sheet 22 may be formed from materials, such as, but not limited to, polyvinyl chloride, thermoplastic polyurethane sheet and silicone sheet. The sheet 22 may include one or more polytetrafluoroethylene coatings 34 to prevent polyvinyl chloride from sticking during formation of the sheet. The sheet 22 may include one or more top layers of polypropylene.

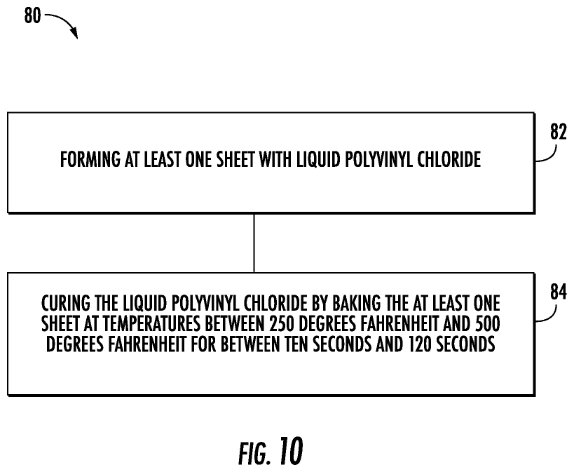

In at least one embodiment, as shown in FIG. 10 at 80, one or more sheets 22 of the simulated embroidery system may be formed at 82 from liquid polyvinyl chloride. In at least one embodiment, the sheet 22 may be formed by pouring liquid polyvinyl chloride (PVC) on a polytetrafluoroethylene sheet. The liquid polyvinyl chloride may be colored, such as, but not limited to, white or other desired colors. The sheet 22 may be formed by curing at 84 the liquid polyvinyl chloride by baking the sheet 22 at temperatures between 250 degrees Fahrenheit and 500 degrees Fahrenheit for between ten seconds and 120 seconds. In at least one embodiment, the sheet 22 may be formed by curing the liquid polyvinyl chloride by baking the sheet 22 at about 350 degrees Fahrenheit for between 30 seconds and 75 seconds. Desired artwork 12 may be added by printing the desired artwork 12 on the sheet 22, such as a liquid polyvinyl chloride formed sheet 22, via printing by a printer, such as, but not limited to, a digital printer, such as an ultraviolet, solvent, eco solve or latex printer. A static prevention layer 36 may be added onto the sheet 22 to avoid electric shock. The static prevention layer 36 may be, but is not limited to being, a layer of polypropylene.

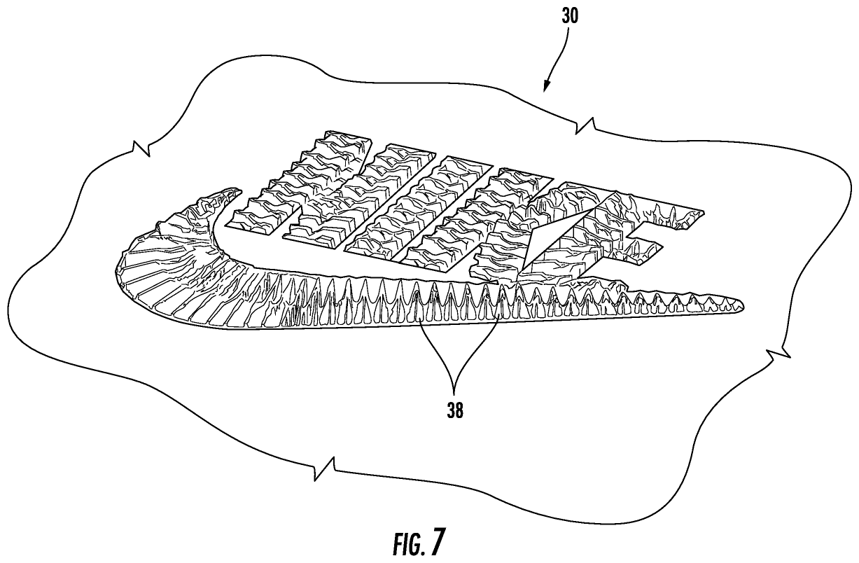

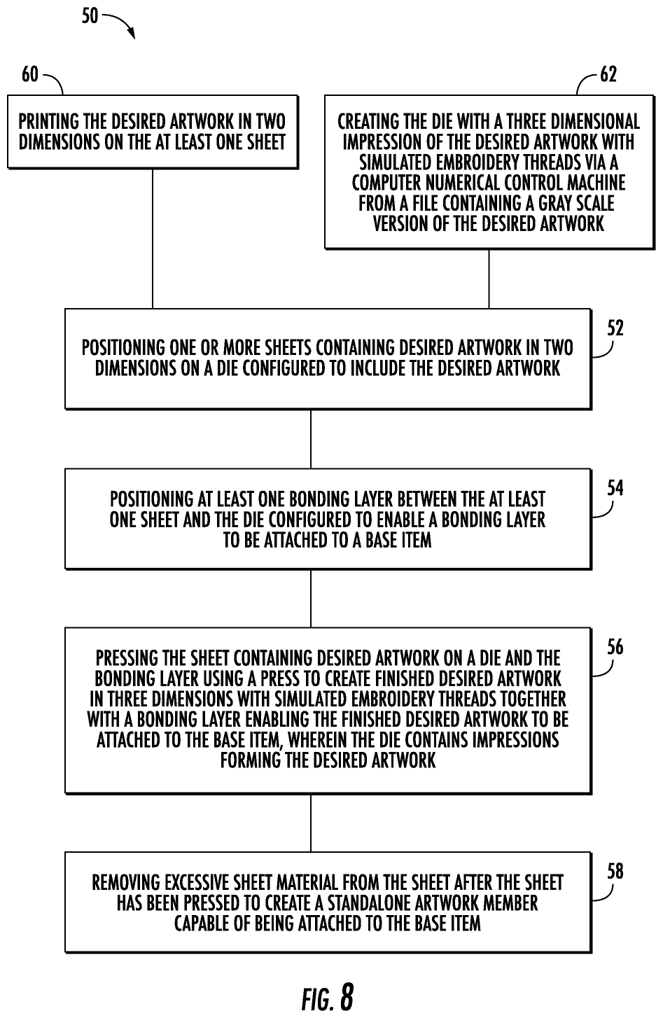

The desired artwork 12 printed on the sheet 22 may be the same as the artwork used to create impressions forming the die 30. As such, the desired artwork 12 is printed on the sheet 22 in two dimensions. The desired artwork 12 is used to create impressions 38, as shown in FIG. 7, on the die 30 in three dimensions. In at least one embodiment, the desired artwork 12 printed on the sheet 22 may include simulated embroidery threads. The desired artwork 12 used to create impressions 38 forming the die 30 may include simulated embroidery threads. In at least one embodiment, both the sheet 22 and the impressions 38 forming the die 30 include simulated embroidery threads. In other embodiments, one of the sheet 22 or the impressions 38 forming the die 30 include simulated embroidery threads.

In at least one embodiment, the desired artwork 12 may be prepared as a file usable by a computer numerical control (CNC) machine. An illustrator using vector files created from numerous lines may be used. A photograph or simulation of desired artwork 12 may be used and converted to a black and white image, thereby displaying the image in grayscale where white is zero depth, black is 100 percent depth and various degrees of gray is between 0 and 100. Vector art may be created of the black and white image of the desired artwork 12. A middle center line may be created of the desired artwork 12. A brush that is suable to mimic threads of embroidery is used to create simulated embroidery threads by moving the brush in the direction of the centerline. The brush may be trimmed using outer vectors. The desired artwork 12 may be converted on a simulated embroidery image. The desired artwork 12 may be converted into a two-dimensional vector image file, which may in turn be converted into a three dimensional vector image file ready to be used on a CNC machine to create a die 30 with impressions 38 forming the desired artwork 12.

In at least one embodiment, the desired artwork 12 may be prepared as a file in another way usable by a computer numerical control (CNC) machine. Desired artwork 12 may be created via embroidery. The embroidered desired artwork 12 may then be scanned to create a high resolution digital file of the embroidered desired artwork 12. The high resolution digital file of the embroidered desired artwork 12 may be converted into a black and white image as a grayscale image. The grayscale image may be enhanced to create a depth map of the image. The grayscale image may be processed using a three-dimensional software, such as, but not limited to, CARVECO and ART CAM, to create a grayscale depth to be three dimensionally carved. This grayscale image of the desired artwork 12 may be used to drive a CNC machine to create a die 30 with impressions 38 forming the desired artwork 12.

Once the desired artwork 12 has been created and saved onto a file that is readable by a CNC machine. The CNC machine may be used to create one or more dies containing impressions 38 forming the desired artwork 12 in three dimensions with simulated embroidery threads, whereby the die 30 is formed via a computer numerical control machine from a file containing a gray scale version of the desired artwork 12. The die 30 may be formed from material, such as, but not limited to, aluminum. A method of creating a die 30 usable to create a standalone item with desired artwork 12 in three dimensions with simulated embroidery threads may include creating a file with a grayscale image of desired artwork 12 and cutting material from a block of material using the file of the grayscale image of desired artwork 12 with a CNC machine to create a three-dimensional impression of the desired artwork 12. The method may also include creating the die with impressions 38 simulating embroidery threads.

The bonding layers 24 of the simulated embroidery emblems 18 of the embroidery simulation system 10 may be formed from one or more polyurethane bonding films. The polyurethane bonding films may be usable to attach to soft surfaced goods, such as, but not limited to, garments, such as, but not limited to, shirts, jackets and pants; hats; bookbags; soft sided coolers; fabric on furniture and soft gear; such as, but not limited to, chairs, tents and other camping and outdoor gear. The polyurethane bonding films may be attached to soft surfaced goods by applying heat to the polyurethane bonding films, such as via an iron and the like. The simulated embroidery emblems 18 of the embroidery simulation system 10 may be formed from one or more pressure sensitive adhesives. The pressure sensitive adhesives may be usable to attach to hard surfaced goods, such as, but not limited to, drinkware such as, but not limited to, drinking mugs; hard coolers; laptops; phones; presentation hard cases and suitcases. The pressure sensitive adhesives may be attached to hard surfaced goods by applying pressure to the pressure sensitive adhesives.

A method of creating simulated embroidery, as shown as 50 in FIG. 8, may include positioning at 52 one or more sheets containing desired artwork 12 on a die 30 configured to include the desired artwork 12. The desired artwork 12 may be in two or more dimensions. The method may include positioning at 54 one or more bonding layers between the sheet 22 and the die 30 configured to enable a bonding layer 24 to be attached to a base item 32. The method may include pressing at 56 the sheet 22 containing desired artwork 12 on a die 30 and the bonding layer 24 using a press to create finished desired artwork 12 in three dimensions with simulated embroidery threads together with a bonding layer 24 enabling the finished desired artwork 12 to be attached to the base item 32, whereby the die 30 may contain impressions 38 forming the desired artwork 12.

In at least one embodiment, the action of positioning one or more sheets 22 may include positioning the sheet 22 formed from one or more polyvinyl chloride sheets on the die 30. The action of positioning one or more sheets 22 may include positioning the sheet 22 formed from one or more thermoplastic polyurethane sheets on the die 30. The action of positioning one or more sheets 22 may include positioning the sheet 22 formed from one or more silicone sheets on the die 30. The action of positioning one or more sheets 22 may include positioning the sheet 22 including at least one polytetrafluoroethylene coating thereon.

In at least one embodiment, the action of positioning one or more bonding layers 24 between the one or more sheets 22 and the die 30 may include positioning one or more bonding layers 24 formed from a polyurethane bonding film. The action of positioning one or more bonding layers 24 between the one or more sheets 22 and the die 30 may include positioning one or more bonding layers 24 formed from a pressure sensitive adhesive.

The method may also include printing at 60 in FIG. 8 the desired artwork 12 in two dimensions on the sheet 22. Printing the desired artwork 12 on the sheet 22 may include printing the desired artwork 12 using digital printing, screen printing or other printing process. The action of printing the desired artwork 12 in two dimensions on the sheet 22 may include printing desired artwork 12 having an appearance of embroidery threads.

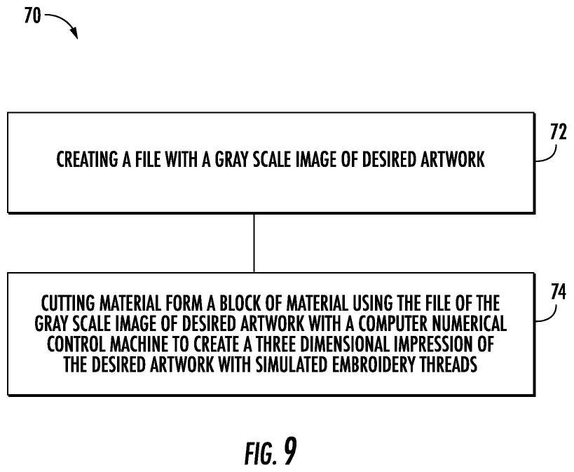

The method may include creating the die at 62 in FIG. 8 with a three-dimensional impression of the desired artwork with simulated embroidery threads via a computer numerical control machine from a file containing a gray scale version of the desired artwork, as previously set forth. The method may include creating a die 30 usable to create a standalone item at 70 in FIG. 9 with desired artwork 12 in three dimensions with simulated embroidery threads. The method may include creating a file at 72 with a grayscale image of the desired artwork 12. The method may include cutting material at 74 from a block of material using the file of the grayscale image of desired artwork 12 with a CNC machine to create a three-dimensional impression 38 of the desired artwork 12 with simulated embroidery threads in the material. The method of creating the die may include creating the die 30 with impressions 38 simulating threads forming embroidery.

As previously set forth, the method may include pressing the sheet 22 containing desired artwork 12 on a die 30 and the bonding layer 24 using a press to create finished desired artwork 12 in three dimensions with simulated embroidery threads together with a bonding layer 24 enabling the finished desired artwork 12 to be attached to the base item 32. In at least one embodiment in which pressing the one or more sheets 22 containing desired artwork 12 and one or more bonding layers 24 on a die 30 using a press may include pressing the sheet 22 using a high frequency machine stamp. This process may be referred to as welding whereby a press, such as, but not limited to, a high frequency machine stamp is used to press the sheet 22 and the bonding layer 24 onto the impressions 38 on the die 30 to create finished desired artwork 12 attached to a bonding layer 24 that is attachable to soft surfaced or hard surfaced goods. In at least one embodiment, the finished desired artwork 12 may include simulated embroidery threads.

The method may include removing at 58, as shown in FIG. 8, excessive sheet material from the sheet 22 after the sheet 22 has been pressed to create a standalone artwork member capable of being attached to a base item 32. In at least one embodiment, the action of removing excessive sheet material from the sheet 22 may occur during the action of pressing the sheet 22 and bonding layer 24 together on the die 30. In particular, the sheet 22 and bonding layer 24 may be pressed into contact with the impressions 38 on the die 30 and on a cutting arris 40 on the die 30 or positioned in close proximity to the die 30 such that the act of pressing also trims excessive material from the sheet 22 and bonding layer 24. Once the excessive material has been removed, the standalone artwork member is ready to be attached to a desired base item 32.

During use, once the sheet 22 with desired artwork 12 and bonding layer 24 are pressed together and the excessive material has been removed, the standalone artwork member is ready to be attached to a desired base item 32. The standalone artwork member may be attached to a desired base item 32, such as, but not limited to, soft surfaced goods when the bonding layer 24 is a polyurethane bonding film and hard surfaced goods when the bonding layer 24 is a polypropylene film. The system 10 and methods disclosed herein saves significant amounts of time ordinarily required for embroidery. An embroidered logo is generally perceived as having a better appearance than other types of installation and attachment systems. The system 10 and methods disclosed herein enables one to enjoy the aesthetics of desired artwork 12 having simulated embroidery that very closely mimics authentic embroidery without requiring the investment of time needed to create an embroidered item on a good.

A merchant, business or other may create numerous standalone artwork members and keep them on hand ready to be attached to a soft surfaced good or hard surfaced good when desired and once a customer or other decisionmaker has decided which base item the standalone artwork member is to be attached. By not requiring an item to be embroidered ahead of time for a potential customer, one need not have multiple sizes of each garment and in numerous colors already embroidered with a logo. Instead, the garments or other items need not have a logo attached thereto until after a customer chooses which item to purchase. One a customer decides on an item, the standalone artwork member may be attached to the item by heating the standalone artwork member or by pressing the standalone artwork member on a base item.

The foregoing is provided for purposes of illustrating, explaining, and describing embodiments of this invention. Modifications and adaptations to these embodiments will be apparent to those skilled in the art and may be made without departing from the scope or spirit of this invention.

What is claimed is:

1. An embroidery simulation system, comprising:
at least one sheet containing desired artwork in two dimensions; and
at least one bonding layer between the at least one sheet and a die, wherein the at least one bonding layer is configured to enable the at least one sheet to be attached to a base item.

2. The embroidery simulation system of claim 1, wherein the at least one sheet comprises at least one polyvinyl chloride sheet.

3. The embroidery simulation system of claim 1, wherein the at least one sheet comprises at least one thermoplastic polyurethane sheet.

4. The embroidery simulation system of claim 1, wherein the at least one sheet comprises at least one silicone sheet.

5. The embroidery simulation system of claim 1, further comprising at least one polytetrafluoroethylene coating on the at least one sheet.

6. The embroidery simulation system of claim 1, wherein the at least one bonding layer comprises at least one polyurethane bonding film.

7. The embroidery simulation system of claim 1, wherein the at least one bonding layer comprises at least one pressure sensitive adhesive.

8. The embroidery simulation system of claim 1, further comprising at least one die containing impressions forming the desired artwork in three dimensions with simulated embroidery threads, wherein the die is formed via a computer numerical control machine from a file containing a gray scale version of the desired artwork.

9. A method of creating simulated embroidery, comprising:
positioning at least one sheet containing desired artwork in two dimensions on a die configured to include the desired artwork;
positioning at least one bonding layer between the at least one sheet and the die configured to enable a bonding layer to be attached to a base item; and
pressing the at least one sheet containing desired artwork on a die and the at least one bonding layer using a press to create finished desired artwork in three dimensions with simulated embroidery threads together with a bonding layer enabling the finished desired artwork to be attached to the base item, wherein the die contains impressions forming the desired artwork.

10. The method of claim 9, wherein positioning at least one sheet comprises positioning the at least one sheet comprising at least one polyvinyl chloride sheet on the die.

11. The method of claim 9, wherein positioning at least one sheet comprises positioning the at least one sheet comprising at least one thermoplastic polyurethane sheet on the die.

12. The method of claim 9, wherein positioning at least one sheet comprises positioning the at least one sheet comprising at least one silicone sheet on the die.

13. The method of claim 9, wherein positioning at least one sheet comprises positioning the at least one sheet comprising at least one polytetrafluoroethylene coating.

14. The method of claim 9, wherein positioning at least one bonding layer between the at least one sheet and the die comprises positioning at least one bonding layer formed from a polyurethane bonding film.

15. The method of claim 9, wherein positioning at least one bonding layer between the at least one sheet and the die comprises positioning at least one bonding layer formed from a pressure sensitive adhesive.

16. The method of claim 9, further comprising printing the desired artwork in two dimensions on the at least one sheet.

17. The method of claim 12, wherein printing the desired artwork in two dimensions on the at least one sheet comprises printing desired artwork having an appearance of embroidery threads.

18. The method of claim 9, further comprising creating the die with a three dimensional impression of the desired artwork with simulated embroidery threads via a computer numerical control machine from a file containing a gray scale version of the desired artwork.

19. The method of claim 9, wherein pressing the at least one sheet containing desired artwork and at least one bonding layer on a die using a press comprises pressing the at least one sheet using a press comprising a high frequency machine stamp.

20. The method of claim 9, further comprising removing excessive sheet material from the at least one sheet after the at least one sheet has been pressed to create a standalone artwork member capable of being attached to the base item.

21. A method of forming a base sheet of a simulated embroidery system, comprising:
forming at least one sheet with liquid polyvinyl chloride; and
curing the liquid polyvinyl chloride by baking the at least one sheet at temperatures between 250 degrees Fahrenheit and 500 degrees Fahrenheit for between ten seconds and 120 seconds.

22. The method of claim 21, wherein creating the at least one sheet comprises creating the at least one sheet with a top layer of polypropylene.

23. A method of creating a die usable to create a standalone item with desired artwork in three dimensions with simulated embroidery threads, comprising:
creating a file with a gray scale image of desired artwork; and
cutting material form a block of material using the file of the gray scale image of desired artwork with a computer numerical control machine to create a three dimensional impression of the desired artwork with simulated embroidery threads.
